(19) United States
(12) Patent Application Publication
(10) Pub. No.: US 2019/0264578 A1
(43) Pub. Date: Aug. 29, 2019

(54) TURBINE SHROUD ASSEMBLY

(71) Applicant: Rolls-Royce Corporation, Indianapolis, IN (US)

(72) Inventor: Jeffrey A. Walston, Indianapolis, IN (US)

(21) Appl. No.: 15/903,824

(22) Filed: Feb. 23, 2018

(51) Int. Cl. F01D 25/24; F01D 11/08; F01D 25/12

(52) U.S. Cl. CPC F01D 25/246; F01D 11/08; F01D 25/12; F05D 2220/32; F05D 2300/6033; F05D 2260/20; F05D 2240/11

(57) ABSTRACT

A turbine shroud or other assembly adapted for use in a gas turbine engine is disclosed in this paper. In illustrative embodiments, a metallic carrier included in the assembly is configured to be manufactured by casting or additive layer manufacturing.

### FIELD OF THE DISCLOSURE

The present disclosure relates generally to assemblies including ceramic matrix composite components, and more specifically to turbine shroud and other assemblies used in gas turbine engines.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

Compressors and turbines typically include alternating stages of static vane assemblies and rotating wheel assemblies. The rotating wheel assemblies include disks carrying blades around their outer edges. When the rotating wheel assemblies turn, tips of the blades move along blade tracks included in static shrouds that are arranged around the rotating wheel assemblies. Such static shrouds may be coupled to an engine case that surrounds the compressor, the combustor, and the turbine.

Some shrouds positioned in the turbine may be exposed to high temperatures from products of the combustion reaction in the combustor. Such shrouds sometimes include components made from ceramic matrix composite materials suitable for use in high temperature environments. Due to material properties of ceramic matrix composite materials, coupling such components to metallic parts of a shroud assembly can present challenges.

### SUMMARY

The present disclosure may comprise one or more of the following features and combinations thereof.

According to one aspect of the present disclosure, a turbine shroud adapted mount outward of blades included in a turbine wheel assembly and block gasses from passing over the blades without interacting with the blades. The turbine shroud includes a blade track segment including ceramic matrix composite materials and a carrier segment including metallic materials. The blade track segment further includes a runner that extends partway around a central axis to face a primary gas path of the gas turbine engine and an attachment feature that extends radially outward from the runner away from the central axis. The carrier segment is configured to be mounted to other metallic components within the gas turbine engine.

In illustrative embodiments, the carrier segment is shaped to form a relief of a portion of a radially-outwardly facing side of the blade track segment such that a constant gap is formed between a portion of the runner and the attachment feature. The carrier segment is formed to include a central panel and peripheral walls. The central panel is surrounded by the peripheral walls and shaped to form the relief of the portion of the radially-outwardly facing side of the blade track segment. The peripheral walls are arranged radially outward of and along forward, aft, and circumferential side edges of the runner included in the blade track segment.

In illustrative embodiments, the turbine shroud further includes seal elements received in radially-inwardly opening channels formed by at least some of the peripheral walls. The central panel forms a primary sheet of material with a substantially constant thickness and reinforcement ribs that extend radially outwardly from the primary sheet of material to reinforce the primary sheet of material.

In illustrative embodiments, the central panel is formed to include a plurality of cooling air holes sized to carry cooling air to the radially-outwardly facing side of the blade track segment and arranged to discharge cooling air toward the radially-outwardly facing side of the blade track segment at a uniform distance from the blade track segment. The plurality of cooling air holes is formed at least in part in the reinforcement ribs of the central panel.

In illustrative embodiments, the attachment feature of the blade track segment is formed to include an eyelet that extends through the attachment feature and the turbine shroud further includes an attachment pin that extend through eyelet to couple the blade track segment to the carrier segment.

In illustrative embodiments, the carrier segment is formed to include a central panel and peripheral walls. The central panel surrounded by the peripheral walls and shaped to form the relief of the portion of the radially-outwardly facing side of the blade track segment. The peripheral walls are formed to include apertures through which the attachment pin extends to couple the blade track segment to the carrier segment. The peripheral walls are arranged radially outward of and along forward, aft, and circumferential side edges of the runner included in the blade track segment.

In illustrative embodiments, the central panel forms a primary sheet of material with a substantially constant thickness and reinforcement ribs that extend radially outwardly from the primary sheet of material to reinforce the primary sheet of material. The reinforcement ribs are formed to include a plurality of cooling air holes sized to carry cooling air toward the radially-outwardly facing side of the blade track segment.

In illustrative embodiments, the turbine shroud further includes seal elements received in radially-inwardly opening channels formed by at least some of the peripheral walls. The carrier segment is formed to include hanger brackets that extend from the peripheral walls and that are configured to couple the carrier segment to a turbine case.

According to another aspect of the present disclosure, a turbine shroud is adapted to be mounted outward of blades included in a turbine wheel assembly and block gasses from passing over the blades without interacting with the blades. The turbine shroud includes a blade track including ceramic matrix composite materials and a carrier segment including metallic materials. The blade track segment has a runner that extends partway around a central axis to face a primary gas path of the gas turbine engine and an attachment post. The attachment post shaped to extend radially outward from the runner away from the central axis and to include an eyelet therethrough,

In illustrative embodiments, the carrier segment is formed to include a forward peripheral wall that extends along a forward edge of the runner with an aperture formed therethrough, an aft peripheral wall that extends along an aft edge of the runner with an aperture formed therethrough, and a central panel that extends from the forward peripheral wall to the aft peripheral wall. The central panel is shaped to form a relief of a portion of a radially-outwardly facing side of the blade track segment such that a constant gap is formed between the blade track segment and the carrier segment.

In illustrative embodiments, the turbine shroud further includes an attachment pin that extends through the eyelet formed in the attachment post and through the apertures formed in both the forward peripheral wall and the aft peripheral wall to couple the blade track segment to the carrier segment.

In illustrative embodiments, the central panel is formed to include a plurality of cooling air holes sized to carry cooling air to the radially-outwardly facing side of the blade track segment and arranged to discharge cooling air toward the radially-outwardly facing side of the blade track segment at a uniform distance from the blade track segment. The central panel forms a primary sheet of material with a substantially constant thickness and reinforcement ribs that extend radially outwardly from the primary sheet of material to reinforce the primary sheet of material. The plurality of cooling air holes are formed at least in part in the reinforcement ribs of the central panel.

In illustrative embodiments, the carrier segment is formed to include side peripheral walls that extend from the forward peripheral wall to the aft peripheral wall along circumferential side edges of the runner included in the blade track segment, and the central panel extends between the side peripheral walls of the carrier segment.

In illustrative embodiments, the turbine shroud further includes seal elements received in radially-inwardly opening channels formed by the side peripheral walls of the carrier segment and engaged with the radially-outwardly facing side of the blade track segment to seal the constant gap formed between the blade track segment and the carrier segment.

In illustrative embodiments, the central panel is formed to include a primary sheet of material with a substantially constant thickness, reinforcement ribs that extend radially outwardly from the primary sheet of material to reinforce the primary sheet of material, and a plurality of cooling air holes that extend, at least in part, through the reinforcement ribs and that are sized to carry cooling air to the constant gap formed between the blade track segment and the carrier segment. These and other features of the present disclosure will become more apparent from the following description of the illustrative embodiments.

### BRIEF DESCRIPTION OF THE DRAWINGS

FIG. 1 is a cut-away perspective view of a gas turbine engine showing that the exemplary engine includes a fan driven by an engine core having a compressor, a combustor, and a turbine;

FIG. 2 is a partial cross-sectional view of the gas turbine engine of FIG. 1 showing the arrangement of a segmented turbine shroud radially outward of blades included in a turbine wheel assembly to suggest that the turbine shroud blocks gasses from passing over the blades without interacting with the blades;

FIG. 3 is an exploded assembly view of the turbine shroud segment of FIG. 5 showing that the turbine shroud segment includes, from bottom to top, a blade track segment, a pair of attachment pins, and a carrier segment;

FIG. 4 is a perspective and sectional view of the turbine segment in the circumferential direction showing a portion of the blade track segment received in the carrier segment and showing the attachment pin extending through an eyelet formed in the blade track segment to couple the blade track segment to the carrier segment;

FIG. 5 is a perspective and sectional view of the turbine segment in an axially forward-looking direction showing that the blade track segment and the carrier segment interface with one another such that a constant gap is provided between at least a portion of the blade track segment and the carrier segment;

FIGS. 6A and 6B are a series of enlarged sectional views of a portion of the turbine segment showing that the carrier segment includes a primary sheet and a plurality of reinforcement ribs extending radially upward from the primary plate and showing that cooling passages are formed in the reinforcement ribs to provide cooling air to components in the turbine segment;

FIG. 6A is an enlarged sectional view of a portion of the turbine segment in the axially forward direction showing that some of the cooling passages extend radially downward and open in the constant gap to provide cooling air for the blade track segment;

FIG. 6B is an enlarged sectional view of a portion of the turbine segment in the axially aft direction showing that the cooling passages have include impingement passages extending from a radially-outward facing side of the carrier to the reinforcement ribs and vent passages extending from the constant gap to a side of a peripheral wall of the carrier; and

FIG. 7 is a bottom elevation view of the turbine segment with the blade track segment removed to show that the impingement passages are arranged axially forward of the vent passages so that cooling air entering the gap flows through the gap to the vent passages to increase cooling efficiencies.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

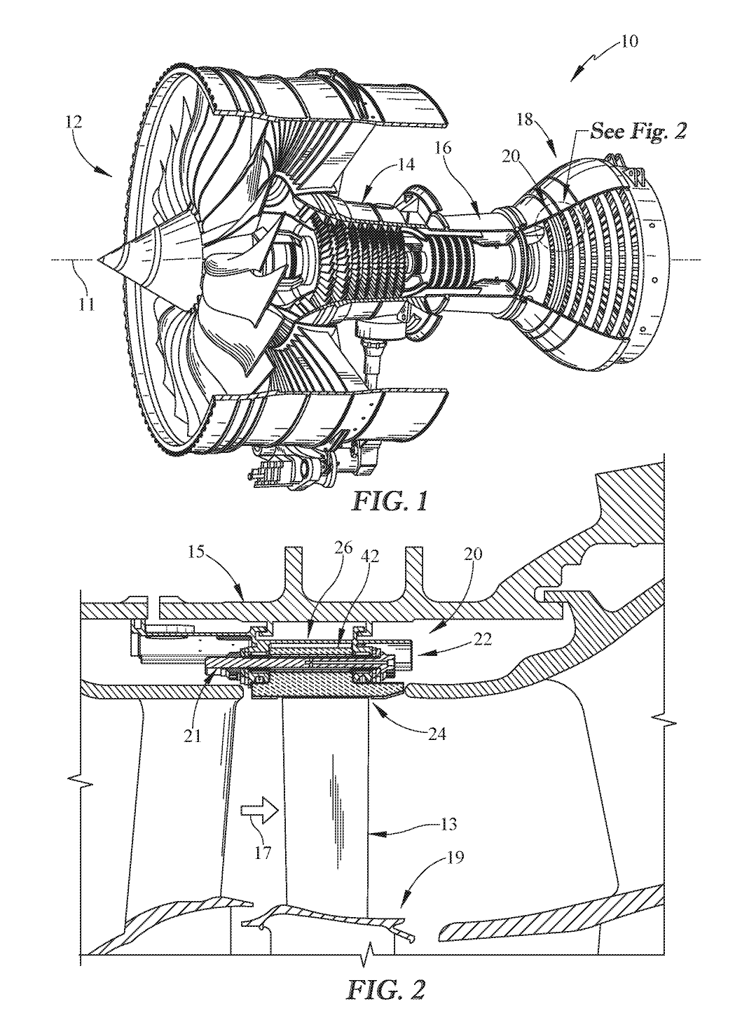

An illustrative aerospace gas turbine engine 10 includes a fan 12, a compressor 14, a combustor 16, and a turbine 18 as shown in FIG. 1. The fan 12 is driven by the turbine 18 and provides thrust for propelling an air vehicle. The compressor 14 compresses and delivers air to the combustor 16. The combustor 16 mixes fuel with the compressed air received from the compressor 14 and ignites the fuel. The hot, high-pressure products of the combustion reaction in the combustor 16 are directed into the turbine 18 to cause the turbine 18 to rotate about a central axis 11 and drive the compressor 14 and the fan 12.

The turbine 18 includes at least one turbine wheel assembly 19 and a turbine shroud 20 positioned to surround the turbine wheel assembly 19 as shown in FIGS. 1 and 2. The turbine shroud 20 is coupled to an outer case 15 of the gas turbine engine 10. The turbine wheel assembly 19 includes a plurality of blades 13 coupled to a rotor disk for rotation therewith. The hot, high pressure combustion products from the combustor 16 are directed toward the blades 13 of the turbine wheel assemblies 19 along a flow path 17. The blades 13 are in turn pushed by the combustion products to cause the turbine wheel assembly 19 to rotate; thereby, driving the rotating components of the compressor 14 and/or the fan 12.

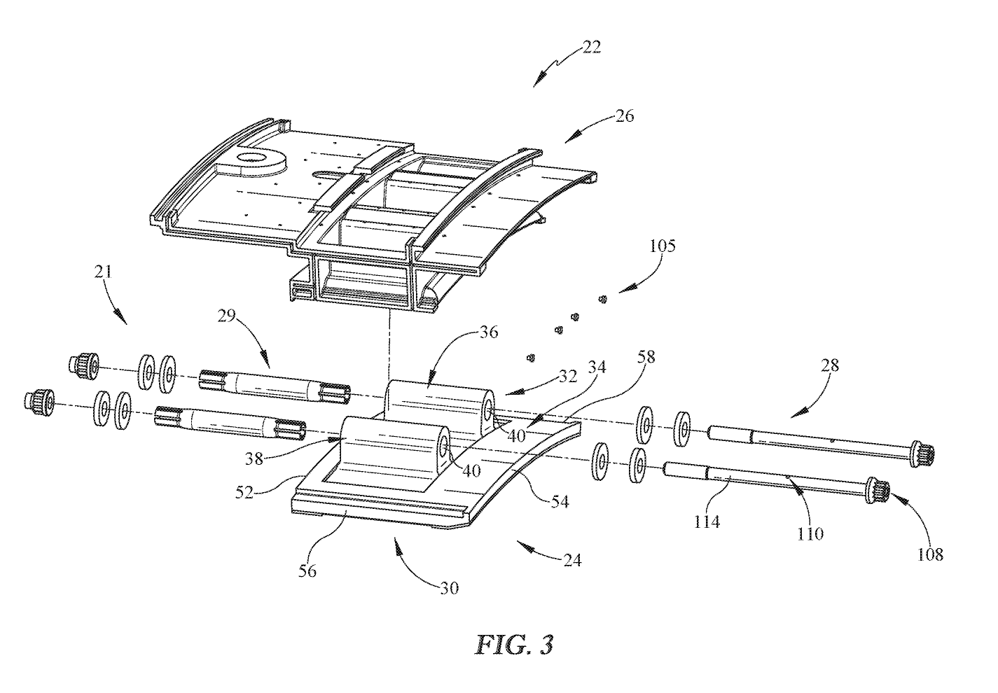

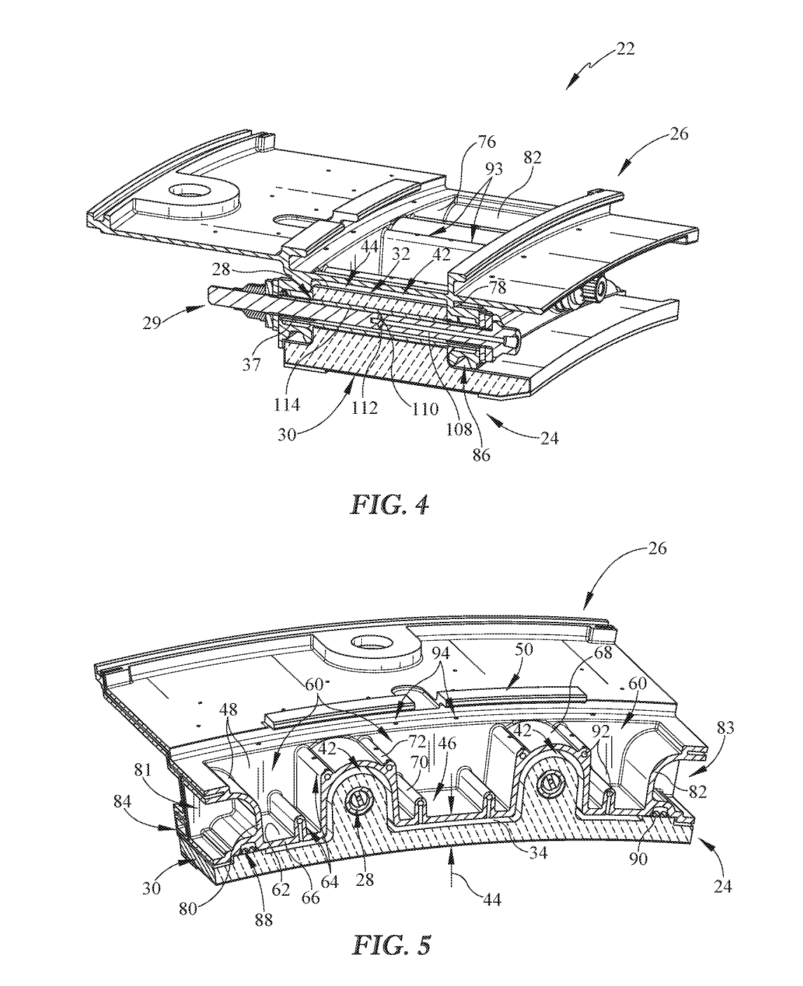

The turbine shroud 20 extends around the turbine wheel assembly 19 to block combustion products from passing over the blades 13 without pushing the blades 13 to rotate as suggested in FIG. 2. In the illustrative embodiment, the turbine shroud 20 is made up of a number of shroud segments 22, one of which is shown in FIGS. 3 and 4, that extend only part-way around the central axis 11 and cooperate to surround the turbine wheel assembly 19. The shroud segments 22 are sealed against one another, such as by strip seal members, to provide a continuous turbine shroud 20. In certain embodiments, certain components of the turbine shroud 20 are segmented while other components are annular and non-segmented.

Each shroud segment 22 includes a blade track segment 24, a carrier segment 26, and attachment pin 29 a mount assembly 21 configured to couple the blade track segment 26 to the carrier segment 24 as shown in FIG. 2 and suggested in FIG. 3. The blade track segment 24 is a ceramic matrix composite component configured to directly face the high temperatures of the primary gas path. The carrier segment 26 is a metallic support component configured to interface with other metallic components spaced from the primary gas path of the engine 10. The mount assembly 21 includes attachment pins 29 and bolts 28 that provide cooling-air distributors configured to provide cooling air for the attachment pins 29 to extend the life of the attachment pins 29.

The blade tracks segment 24 of each shroud segment 22 comprises ceramic matrix composite materials as suggested in FIGS. 2 and 4. The blade track segment 24 is held in place adjacent to tips of turbine blades 13 to block combustion products from passing over the blades 13 without pushing the blades 13 to rotate as suggested in FIG. 2. The blade track segment 24 is illustratively formed to include a runner 30 and an attachment feature 32 as shown in FIG. 3. The runner 30 is arcuate and extends partway around axis 11 adjacent to turbine blades 13. The attachment 32 extends radially outward from the runner 30 to provide structure for coupling the blade track segment 24 to the carrier segment 26. Both the runner 30 and the attachment 32 define a radially-outward facing side 34 of the blade track segment 24 that interfaces with the carrier segment 26.

In the illustrative embodiment, the attachment 32 of the blade track segment 24 includes two attachment posts 36, 38 as shown in FIG. 3. The attachment posts 36, 38 are circumferentially spaced apart from one another and extend part-way across the runner 30 in the axial direction parallel to the central axis 11. Each attachment post 36, 38 is formed to include an axially-extending eyelet 40 sized to receive a respective attachment pin 29 and bolt 28. When a segment 22 is assembled, the attachment posts 36, 38 are located so that the eyelets 40 are aligned with mount apertures 37 included in the carrier segment 26. The bolts 28 and attachment pins 29 are inserted through apertures 37 and eyelets 40 to couple the blade track segments 26 to the carrier segments 24.

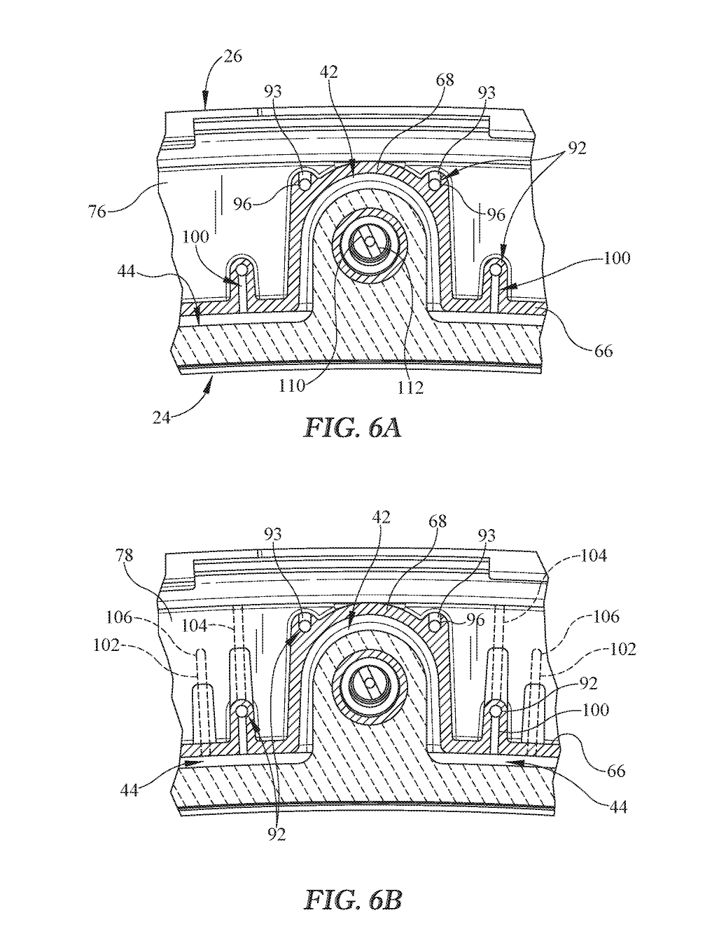

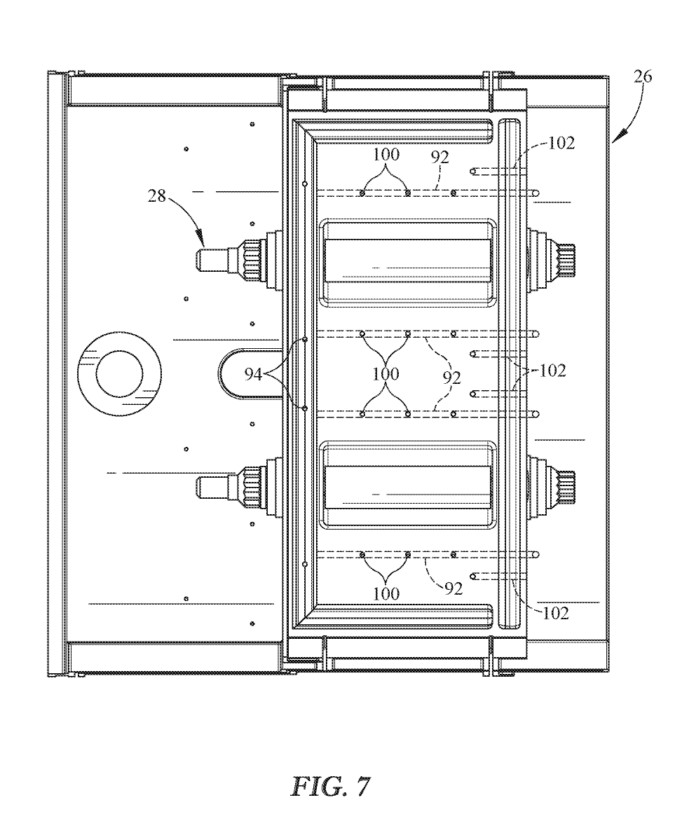

The carrier segment 26 included in each shroud segment 22 is coupled to an outer case 15 of the engine 10 as shown in FIG. 2. The carrier segment 26 is shaped to interface with the blade track segment 24 and forms a relief 42 of a portion of the radially-outward facing side 34 of the blade track segment. The relief 42 allows the attachment feature 32 to extend radially outward beyond a portion of the carrier segment 26 while another portion of the carrier supports the runner 30 of the blade track segment 24 as shown in FIG. 4. A constant gap 44 is formed and maintained between the carrier segment 26 and some of the blade track segment 24 including a portion of the runner 30 and the attachment feature 32 as shown in FIG. 5. A plurality of cooling holes open into the gap 44 and cooperate with the gap 44 to increase cooling efficiencies for the blade track segment 24 and other components in the turbine segments 22 as shown in FIGS. 6A, 6B, 7.

Each carrier segment 26 illustratively includes a central panel 46, peripheral walls 48, and hanger brackets 50 as shown in FIGS. 3-5. The central panel 46 extends partway around the axis 11. The hanger brackets 50 extend radially outward from the central panel 46 and engage the outer case 15 to couple the turbine shroud segment 22 to the rest of the engine 10. The peripheral walls 48 are arranged radially outward of and along a forward edge 52, an aft edge 54, and circumferential edges 56, 58 of the runner 30.

The central panel 46 is shaped to form the relief 42 of the portion of the radially-outward facing side 34 of the blade track segment 24. The peripheral walls 48 extend radially upward from the central panel 46 and cooperate with the central panel 46 to define an internal space 60 between the walls 48 and radially above the central panel 46. At least a portion of the central panel 46 extends upwardly from the runner 30 and into the internal space 60 to provide the relief 42. The internal space 60 is defined without any undercuts in the central panel 46 and the peripheral walls 34 when viewed in the radially-inward direction to facilitate the removal of casting molds during manufacture of the carrier segment 26 with the relief 42.

The central panel 46 interfaces with the blade track segment 24 and cooperates with the blade track segment 24 such that the constant gap 44 is formed between them as shown in FIG. 5. The central panel 46 includes a primary sheet 62 having a substantially constant thickness and reinforcement ribs 64. The primary sheet 62 defines the relief 42 and cooperates with the blade track segment 24 to provide the gap 44 between them. The reinforcement ribs 64 extend upwardly from the primary sheet 62 into the internal space 60 and reinforce the primary sheet 62. The reinforcement ribs 64 extend from a forward peripheral wall 76 to an aft peripheral wall 78 and increase carrier segment rigidity to minimize an amount of material required to manufacture the carrier segment 26.

The primary sheet 62 has a plurality of lower valley portions 66 separated by upper dome portions 68 that extend radially upward from the valley portions 66 as shown in FIG. 5. The lower valley portions 66 interface with the runner 30 of the blade track segment 24. The dome portions 68 cooperate to define the relief 42. The attachment posts 36, 38 are configured to extend into the relief 42 defined by the dome portions 68. In the illustrative embodiment, the primary sheet 62 includes a pair of dome portions 68 separated by valley portions 66 on each side of the dome portions 68. However, any suitable number of dome and valley portions may be used to define an adequate relief 42 for the blade track segment 24.

In the illustrative embodiment, the reinforcement ribs 64 include valley reinforcement ribs 70 and dome reinforcement ribs 72 as shown in FIG. 5. The valley reinforcement ribs 70 are coupled to the primary sheet 62 on each side of the dome portions 68 of the sheet 62. The dome reinforcement ribs 72 are coupled to the dome portions of the primary sheet 62 radially outward of the valley reinforcement ribs 70. Illustratively, the ribs 70, 72 are formed to include cooling passages that are arranged to lie generally in distal ends of the ribs 70, 72.

The peripheral walls 34 include the forward wall 76, the aft wall 78 spaced aft of the forward wall 76 along the axis 11, and left and right side walls 80, 82 spaced apart circumferentially from one another as shown in FIGS. 4 and 5. The forward and aft walls 76, 78 are each formed to include the mount apertures 37 sized to receive the bolts 28 and attachment pins 29 as shown in FIG. 4. The left and right side walls 80, 82 extend between the forward and aft walls 76, 78 to provide the internal space 60 between the forward and aft walls 76, 78 and the side walls 80, 82.

Each of the peripheral walls 76, 78, 80, 82 is formed to include a radially-inward facing channel 84, 86, 88, 90 as shown in FIGS. 4 and 5. Each of the radially-inward facing channels is configured to receive a seal. The seals cooperate with the runner 30 of the blade track segment 26 to block gases from entering relief 42 and to block cooling fluid from exiting the relief 42 around the peripheral walls. In the illustrative embodiment, a w-shaped seal is located in each of the channels. However, in other embodiments other types of seals may be used such as, for example, a rope seal or a multi-piece seal.

The left and right peripheral walls 80, 82 have a generally concave shape and define spaces 81, 83 that open in each circumferential direction as shown in FIG. 5. Illustratively, the left and right peripheral walls are cast to form the spaces 81, 83 without any undercuts when the peripheral walls 80, 82 and the spaces 81, 83 are viewed from respective circumferential directions. As such, the forming of the peripheral walls 80, 82 defining the spaces 81, 83 without any undercuts facilitates removal of casting molds during manufacture of the carrier segment 26.

A plurality of cooling passages are provided in the turbine segment 22 to cool the blade track segment 24, the carrier segment 26, the attachment pin 29 as shown in FIGS. 4-7. A number of cooling passages are formed in the carrier segment 26 and the attachment pin 29. The cooling passages have a geometric arrangement that increases cooling efficiency as will be described in greater detail below. The cooling air may be supplied from the compressor section 14 of the engine 10 or from any other suitable cooling air source.

The carrier segment 26 is formed to include a plurality of primary sheet cooling passages 92 and a plurality of channel cooling passages 94 as shown in FIGS. 5, 6A, and 6B. The primary sheet cooling passages 92 are formed in the reinforcement ribs 64 and are configured to deliver cooling air to components included in the turbine segment 22 and other components adjacent to the segment 22 such as, for example, outer case 15. The channel cooling passages 94 extend radially through one or more of the peripheral walls. Illustratively, the channel cooling passages 94 extend from a radially outer surface of the carrier segment 26, through a peripheral wall, and deliver cooling air to the radial-inward facing channels defined by the peripheral walls.

The plurality of primary sheet cooling passages 92 extend axially through the reinforcement ribs 64 as shown in FIGS. 6A and 6B. The cooling passages 92 in the dome portions of the primary sheet 62 have axially-extending inlet passages 96 formed in the forward peripheral wall 76 and radially-extending outlet passages 93 spaced apart from one another along the ribs 72. The cooling passages 92 in the reinforcement ribs 70 on the valley portions 66 of the primary sheet 62 are configured to deliver cooling air to the radially-outward facing surface 34 of the blade track segment 24. The cooling passages 92 in the reinforcement ribs 70 on the dome portions 68 of the primary sheet 62 are configured to deliver cooling air to the outer case 15 via outlet passages 93 as shown in FIG. 6A.

The cooling air passages 92 in the reinforcement ribs 70 on the valley portions include a plurality of impingement passages 100 and a plurality of vent passages 102 as shown in FIGS. 6B and 7. The impingement passages 100 extend radially inward from the cooling passages 92 formed in the valley portions 66 of the primary sheet 62. The impingement passages 100 deliver cooling air to the blade track segment 24 in the gap 44 between the blade track segment 24 and the carrier segment 26 as shown in FIGS. 6A and 6B. The vent passages 102 remove the cooling air from the gap 44 to provide a constant flow of cooling air through the gap 44.

An inlet passage 104 extends radially inward from the radially outward facing surface of the carrier segment 26 to the valley reinforcement ribs 70 as shown in FIG. 6B. The inlet passage 104 provides cooling air to the cooling air passages 92 in the reinforcement ribs 70 located in the valley portions 66 of the sheet 62. The cooling air passages 92 in the reinforcement ribs 70 located in the valley portions 66 of the sheet 62 then deliver the cooling air to the impingement passages 100. The vent passages 102 are separate from the impingement passages 100 and the inlet passages 104 and extend radially upward from the gap 44 to an outlet 106 formed in a side of the aft peripheral wall 78. To facilitate manufacturing, the cooling passages 92 formed in the valley reinforcement ribs may also extend through a side of the aft wall 78 and may be blocked with a plurality of plugs 105 as shown in FIG. 3.

The impingement passages 100 are spaced apart axially along the primary sheet and extend through the primary sheet as shown in FIG. 7. The cooling passages 92 formed in the valley reinforcement ribs interconnect the impingement passages 100. The vent passages 102 are arranged axially aft of the impingement passages 100 so that cooling air entering the gap 44 through the impingement passages 100 is conveyed axially through the gap 44 to the vent passages. The arrangement of the impingement passages 100 relative to the vent passages 102 increases cooling efficiencies.

The bolts 28 are formed to include one or more cooling air passages to provide cooling for the attachment pins 29 as suggested in FIGS. 3-4. A primary passage 108 extends from an end of the bolt 28 along a length of the bolt 28. First and second discharge passages 110, 112 extend from the primary passage 108 to an exterior surface 114 of the bolt 28 so as to discharge cooling air from the primary passage 108 at first and second locations in the eyelet 40. The first and second discharge passages 110, 112 are arranged generally perpendicular to the bolt 28 and are collinear. As such, if either of the first and second discharge passages 110, 112 are blocked, cooling air may still exit through the other of the discharge passages.

In illustrative embodiments, CMC components may require certain shapes in order to satisfy requirements for manufacturability as well as reduce structural stresses on the seal segment. As a result, carrier geometry may change to adapt to the needs of the seal segment. Two challenges in designing metallic carriers to house CMC seal segments may arise when the segment requires a fully-enclosed, individual cavity for each segment. This design may resemble a “cartridge seal” concept.

In illustrative embodiments, geometry may become complex in order to satisfy requirements of the seal segment to have a fully sealed septum that exists immediately radially outward of the backside of each segment that is not in fluid communication with the adjacent segments. This may include a radially inward side of the carrier with a relief 42 that may accept the geometry of the segment and meets any requirements the segment may have in terms of attachment scheme or supplying cooling air via impingement and/or venting, as well as employing the perimeter seal technology that may provide the cartridge sealed concept. This relief 42 may be open on only a single side.

In illustrative embodiments, forming this volume to accept the segment may present challenges such as, for example, while casting the carrier geometry. As such a manufacturing method that is suitable due to its cost and established supply chain may be limited when casting features with deep pockets or undercut geometry. The carrier segment 26 disclosed herein may mitigate these challenges.

In illustrative embodiments, the carrier 26 is formed with a relief 42 to accept the segment geometry. This geometric relationship may provide a carrier 26 that is geometrically accommodating of the radially outward shape of the segment 24 while also housing the sealing member that enables the benefits of the “cartridge sealed” design for high pressure seal segment assemblies.

The features of the carrier 26 geometry may be formed via a multi-piece casting tool, each piece of which could conceivably be introduced to or removed from the carrier's surface by moving it in only one direction as there are no undercuts or cross sections that constrict in the draught direction. Other notable features include an increase in rigidity resisting loads and moments applied to the carrier 26 by pressure differentials and interface loads with adjacent engine components. The carrier segment 26 may be lighter than other designs due to the incorporation of rib members into the resulting contoured geometry. The increase in inherent rigidity due to carrier 26 shape may allow thinner carrier walls to transmit loads efficiently and may allow a reduction in carrier 26 weight. In other illustrative embodiments, the carrier segment 26 may be produced through additive layer manufacturing methods rather than casting.

In illustrative embodiments, cooling passages may be included into the now existing contour walls, saving weight that may otherwise be spent on material to place the cooling passages in acceptable positions. In illustrative embodiments, impingement holes may not require a dedicated wall of material in order to place the secondary flow supplies in the acceptable positions. Due to the incorporation of rib members 70 into the ducted geometry, the design may become lighter and more efficient and may eliminate undercut geometry, which may be difficult or impossible to cast. The delivery of cooling air provided by a combination of the source (impingement) and sink (vent) cooling passages as well as the gap 44 as shown in the illustrated example may be a desirable configuration.

In illustrative embodiments, the source passages may allow cooling air to travel aft to the sink passages via the gap 44 following the contour of the segment 26. This arrangement of cooling passages may increase the effectiveness of the cooling air as the ducted flow may run over the radially-outward facing surface of the segment 24 as it moves to exit the gap 44, The cooling air may pick up more thermal energy than it would have if it were free to traverse a large, open cavity in order to move from the source to the sink passages.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A turbine shroud adapted mount outward of blades included in a turbine wheel assembly and block gasses from passing over the blades without interacting with the blades, the turbine shroud comprising
a blade track segment comprising ceramic matrix composite materials, the blade track segment including a runner that extends partway around a central axis to face a primary gas path of the gas turbine engine and an attachment feature that extends radially outward from the runner away from the central axis, and
a carrier segment comprising metallic materials and configured to be mounted to other metallic components within the gas turbine engine, the carrier segment shaped to form a relief of a portion of a radially-outwardly facing side of the blade track segment such that a constant gap is formed between a portion of the runner and the attachment feature.

2. The turbine shroud of claim 1, wherein the carrier segment is formed to include a central panel and peripheral walls, the central panel surrounded by the peripheral walls and shaped to form the relief of the portion of the radially-outwardly facing side of the blade track segment, and the peripheral walls arranged radially outward of and along forward, aft, and circumferential side edges of the runner included in the blade track segment.

3. The turbine shroud of claim 2, further comprising seal elements received in radially-inwardly opening channels formed by at least some of the peripheral walls.

4. The turbine shroud of claim 2, wherein the central panel forms a primary sheet of material with a substantially constant thickness and reinforcement ribs that extend radially outwardly from the primary sheet of material to reinforce the primary sheet of material.

5. The turbine shroud of claim 4, wherein the central panel is formed to include a plurality of cooling air holes sized to carry cooling air to the radially-outwardly facing side of the blade track segment and arranged to discharge cooling air toward the radially-outwardly facing side of the blade track segment at a uniform distance from the blade track segment.

6. The turbine shroud of claim 5, wherein the plurality of cooling air holes are formed at least in part in the reinforcement ribs of the central panel.

7. The turbine shroud of claim 1, wherein the attachment feature of the blade track segment is formed to include an eyelet that extends through the attachment feature and the turbine shroud further comprises an attachment pin that extend through eyelet to couple the blade track segment to the carrier segment.

8. The turbine shroud of claim 7, wherein the carrier segment is formed to include a central panel and peripheral walls, the central panel surrounded by the peripheral walls and shaped to form the relief of the portion of the radially-outwardly facing side of the blade track segment, and the peripheral walls are formed to include apertures through which the attachment pin extends to couple the blade track segment to the carrier segment.

9. The turbine shroud of claim 8, wherein the peripheral walls are arranged radially outward of and along forward, aft, and circumferential side edges of the runner included in the blade track segment.

10. The turbine shroud of claim 8, wherein the central panel forms a primary sheet of material with a substantially constant thickness and reinforcement ribs that extend radially outwardly from the primary sheet of material to reinforce the primary sheet of material.

11. The turbine shroud of claim 10, wherein the reinforcement ribs are formed to include a plurality of cooling air holes sized to carry cooling air toward the radially-outwardly facing side of the blade track segment.

12. The turbine shroud of claim 10, further comprising seal elements received in radially-inwardly opening channels formed by at least some of the peripheral walls.

13. The turbine shroud of claim 10, wherein the carrier segment is formed to include hanger brackets that extend from the peripheral walls and that are configured to couple the carrier segment to a turbine case.

14. A turbine shroud adapted to be mounted outward of blades included in a turbine wheel assembly and block gasses from passing over the blades without interacting with the blades, the turbine shroud comprising
a blade track segment comprising ceramic matrix composite materials, the blade track segment including a runner that extends partway around a central axis to face a primary gas path of the gas turbine engine and an attachment post, the attachment post shaped to extend radially outward from the runner away from the central axis and to include an eyelet therethrough,
a carrier segment comprising metallic materials and configured to be mounted to other metallic components within the gas turbine engine, the carrier segment formed to include a forward peripheral wall that extends along a forward edge of the runner with an aperture formed therethrough, an aft peripheral wall that extends along an aft edge of the runner with an aperture formed therethrough, and a central panel that extends from the forward peripheral wall to the aft peripheral wall, the central panel shaped to form a relief of a portion of a radially-outwardly facing side of the blade track segment such that a constant gap is formed between the blade track segment and the carrier segment, and
an attachment pin that extends through the eyelet formed in the attachment post and through the apertures formed in both the forward peripheral wall and the aft peripheral wall to couple the blade track segment to the carrier segment.

15. The turbine shroud of claim 14, wherein the central panel is formed to include a plurality of cooling air holes sized to carry cooling air to the radially-outwardly facing side of the blade track segment and arranged to discharge cooling air toward the radially-outwardly facing side of the blade track segment at a uniform distance from the blade track segment.

16. The turbine shroud of claim 15, wherein the central panel forms a primary sheet of material with a substantially constant thickness and reinforcement ribs that extend radially outwardly from the primary sheet of material to reinforce the primary sheet of material.

17. The turbine shroud of claim 16, wherein the plurality of cooling air holes are formed at least in part in the reinforcement ribs of the central panel.

18. The turbine shroud of claim 14, wherein the carrier segment is formed to include side peripheral walls that extend from the forward peripheral wall to the aft peripheral wall along circumferential side edges of the runner included in the blade track segment, and the central panel extends between the side peripheral walls of the carrier segment.

19. The turbine shroud of claim 18, further comprising seal elements received in radially-inwardly opening channels formed by the side peripheral walls of the carrier segment and engaged with the radially-outwardly facing side of the blade track segment to seal the constant gap formed between the blade track segment and the carrier segment.

20. The turbine shroud of claim 19, wherein the central panel is formed to include a primary sheet of material with a substantially constant thickness, reinforcement ribs that extend radially outwardly from the primary sheet of material to reinforce the primary sheet of material, and a plurality of cooling air holes that extend, at least in part, through the reinforcement ribs and that are sized to carry cooling air to the constant gap formed between the blade track segment and the carrier segment.
